(19) United States
(12) Patent Application Publication
(10) Pub. No.: US 2024/0391697 A1
(43) Pub. Date: Nov. 28, 2024

(54) ADAPTIVE AUTONOMOUS MOBILE ROBOT TASKING AND MANAGEMENT

(71) Applicant: Dematic Corp., Grand Rapids, MI (US)

(72) Inventors: Ozge C. Sayilar, Austin, TX (US); Dinakar Nallapureddy, Austin, TX (US); Eric A. Gatchalian, Ada, MI (US)

(21) Appl. No.: 18/671,052

(22) Filed: May 22, 2024

Related U.S. Application Data
(60) Provisional application No. 63/503,535, filed on May 22, 2023.

(51) Int. Cl. B65G 1/137; B65G 1/04; B65G 1/06

(52) U.S. Cl. CPC B65G 1/1378; B65G 1/0492; B65G 1/065

(57) ABSTRACT

A material handling system having autonomous mobile robots (AMRs) for retrieving, transporting, and delivering items to and from locations within a facility. The system includes picking stations and a common waiting area. Each picking station is used for picking operations as part of order fulfillment activities in the facility. The common waiting area is associated with at least a subset of picking workstations. The common waiting area provides a temporary holding space for a first AMR of said plurality of AMRs when transporting items for order fulfillment activities at a first picking station that is not ready to receive the first AMR and its items. The first picking station sends a prompt to the first AMR when it's ready for the first AMR and its items. The first AMR will leave the common waiting area and proceed to the first picking station when prompted by the first picking station.

### CROSS REFERENCE TO RELATED APPLICATION

The present application claims the priority benefits of U.S. provisional application, Ser. No. 63/503,535, filed May 22, 2023, which is hereby incorporated herein by reference in its entirety.

### FIELD OF THE INVENTION

The present invention is directed to warehouse automation and, in particular, to movement of inventory/material throughout a warehouse. While the invention is illustrated for use with autonomous mobile robot (AMR) based systems, it should be understood that this term broadly includes automated mobile vehicles, i.e., automated guided vehicles (AGV), drones, humanoid robots, quadruped, etc.

### BACKGROUND OF THE INVENTION

Automated guided vehicles (AGVs) have long been a successful solution to automatically move material to, from, and through manufacturing facilities, warehouses, distribution centers, and other applications. The AGV has evolved with new navigation technology, physical size/payload capabilities, environments and routing abilities and are now often referred to as autonomous mobile robots (AMR). The difference between AGVs and AMRs is one of degree and for the purpose of this document a reference to one shall include the other.

### SUMMARY OF THE INVENTION

The present invention provides an automated warehouse material handling and movement system and method of handling or moving material within a warehouse or material handling facility. The system and method utilize autonomous mobile robots (AMR) and an automated warehouse execution system (WES) to provide for dynamic tasking/task assignment/task selection of AMR in order to move material (e.g. inventory items and containers) within the warehouse. AMRs used in order fulfillment will retrieve products from storage locations, and move the retrieved products to designated picking stations. Each picking station includes a respective buffer queue for ordering the AMRs carrying products for order fulfillment at the picking station. A plurality of picking stations will preferably share a common waiting area used as a temporarily staging location for AMRs carrying product that is not yet ready for order fulfillment activities at a designated picking station. The AMRs are also configured to access a list or queue of tasks, with each AMR operable to self-select from the list of tasks a next task to perform. The AMR, in route to the task, is operable to reassess the selection of the optimal next task to perform and to replace the current task with a different task from the list of tasks. If a replacement task is selected, the current task would be returned to the list of tasks for another AMR to select. The AMRs are also configured to rearrange the order of tasks in their queue such that the tasks are carried out in the most efficient and timely manner. Such ordering of tasks may also include the coordination of tasks between multiple AMRs such that the AMRs avoid blocking each other or creating congestion.

In an aspect of the present invention, an exemplary automated material handling system having a plurality of autonomous mobile robots (AMRs) for retrieving, transporting, and delivering items to and from locations within a material handling facility includes a plurality picking stations and a common waiting area. Each picking station is used for picking operations as part of order fulfillment activities in the material handling facility. The common waiting area is associated with at least a subset of picking workstations. The common waiting area provides a temporary holding space for a first AMR of said plurality of AMRs when transporting items for order fulfillment activities at a first picking station that is not ready to receive the first AMR and its items. The first picking station sends a prompt to the first AMR when its ready for the first AMR and its items. The first AMR will leave the common waiting area and proceed to the first picking station when prompted by the first picking station.

In another aspect of the present invention, an exemplary method of task allocation for a material handling system having a plurality of autonomous mobile robots (AMRs) for retrieving, transporting, and delivering items to and from locations within a material handling facility includes retrieving a first donor tote, with an AMR of the plurality of AMRs, specific to an order. The first donor tote is delivered by the AMR to a waiting area when the order is not active at a picking station. The method further includes delivering, with the AMR, the first donor tote to a first picking station when the order is active at the first picking station.

In yet another aspect of the present invention, another exemplary method of task allocation for a material handling system having a plurality of autonomous mobile robots (AMRs) for retrieving, transporting, and delivering items to and from locations within a material handling facility includes accessing, with an AMR, a list of available tasks. The list of available tasks are accessed via a network. The AMR selects a next task from the list of available tasks. The selection of a new task includes selecting a task with either the lowest travel time or that results in maximized order fulfillment throughput. Accessing the list of available tasks is performed while a current task is finishing within a threshold period of time.

In a further aspect of the present invention, all of the AMRs in the facility are self-selecting AMRs that are capable of communication with a robot control system (RCS) to be either partially or fully controlled by the RCS. In this preferable manner, a particular AMR is capable of self-selecting tasks when it is optimal or advantageous to do so, but may also be controlled by the RCS, at periods when it is optimal or advantageous to do so, such as when an AMR is required in a different region of the facility, for example.

Accordingly, methods and a system are provided to enable an AMR to operate substantially independently within a material handling facility, i.e. the AMR is not significantly reliant on an external or remote RCS, to select tasks to perform within the facility. The method provides a dynamic or adaptive AMR workflow logic that enables AMR to self-select tasks to perform. The AMRs include onboard computers adapted to communicate with the WES and to self-select a task to perform from the pending workflow list. The AMRs deliver items to picking stations that are associated with a common waiting area such that an AMR may wait in the common waiting area until a requesting picking station is ready for the AMR. In addition to self-selecting, the AMRs are also operable to select next tasks while a current task is finishing and then while traveling to a current task to re-evaluate the selection of that current task with respect to other available tasks to ensure the AMR has selected the optimal task to perform.

These and other objects, advantages, purposes, and features of this invention will become apparent upon review of the following specification in conjunction with the drawings.

### BRIEF DESCRIPTION OF THE DRAWINGS

FIG. 1 is a block diagram illustrating the operational and control components of an exemplary order fulfillment system;

FIG. 2 is a block diagram of an exemplary aspect of a fulfillment/warehouse facility employing the control system in accordance with the present invention;

FIG. 2A is a block diagram of an exemplary storage system and picking stations of a fulfillment/warehouse facility employing the control system in accordance with the present invention;

FIG. 2B is a block diagram of an arrangement of picking stations from FIG. 2A in accordance with the present invention;

FIG. 2C is a block diagram of another arrangement of picking stations from FIG. 2A and illustrating an exemplary common waiting area in accordance with the present invention;

FIG. 2D is a block diagram of an exemplary autonomous mobile robot (AMR) for use in a fulfillment/warehouse facility in accordance with the present invention;

FIGS. 3A and 3B illustrate the steps to a method for sequencing orders at a pick station that includes a waiting area independent of the pick stations in accordance with the present invention;

FIGS. 4A and 4B illustrate the steps to a method for determining a next task for an autonomous transport robot to perform in an order fulfillment facility in accordance with the present invention;

FIGS. 5A and 5B are block diagrams illustrating the selection of a next task from a queue of assigned tasks with respect to locations of the queued tasks in accordance with the present invention; and

FIG. 5C is a block diagram illustrating the selections of tasks by multiple AMRs within a storage area in accordance with the present invention.

### DESCRIPTION OF THE PREFERRED EMBODIMENTS

The present invention will now be described with reference to the accompanying figures, wherein numbered elements in the following written description correspond to like-numbered elements in the figures. With the industry evolving towards software intensive and intelligent autonomous solutions in order fulfillment strategies, exemplary strategies and solutions must blend fixed and mobile automation (hardware) with flexible workflows (software) and real-time end-to-end visibility with artificial intelligence (AI) enabled decision support capabilities (for the order fulfillment process within a given location). Exemplary methods and systems provide for the sequencing of orders at a pick station that includes a common waiting area independent of the pick stations for temporarily staging donor totes. Such donor totes are delivered by autonomous transportation vehicles. A next task in a queue of tasks is also selected for an autonomous transport vehicle to perform in an order fulfillment facility.

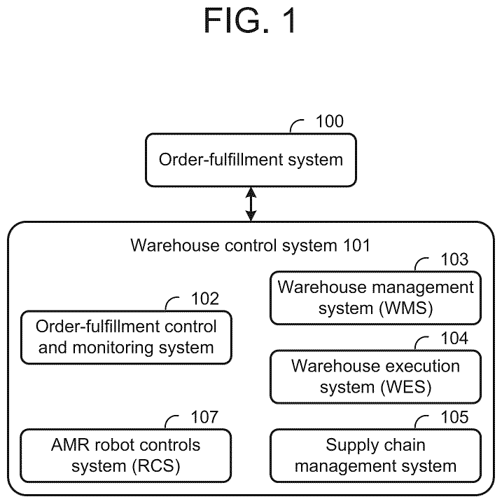

FIG. 1 illustrates an exemplary warehouse environment or aspects thereof in which order fulfillment activities are taking place. It should be appreciated that the order fulfillment systems employing control systems in accordance with the present invention may be configured and employed in numerous ways and environments utilizing variously configured and differing material storage and handling systems. Accordingly, the below discussion of FIG. 1 should be understood as non-limiting and provided for explanatory purposes.

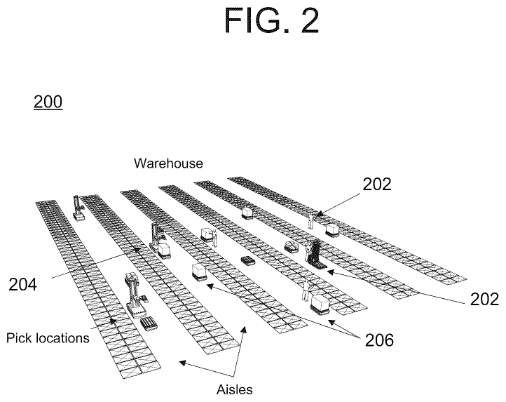

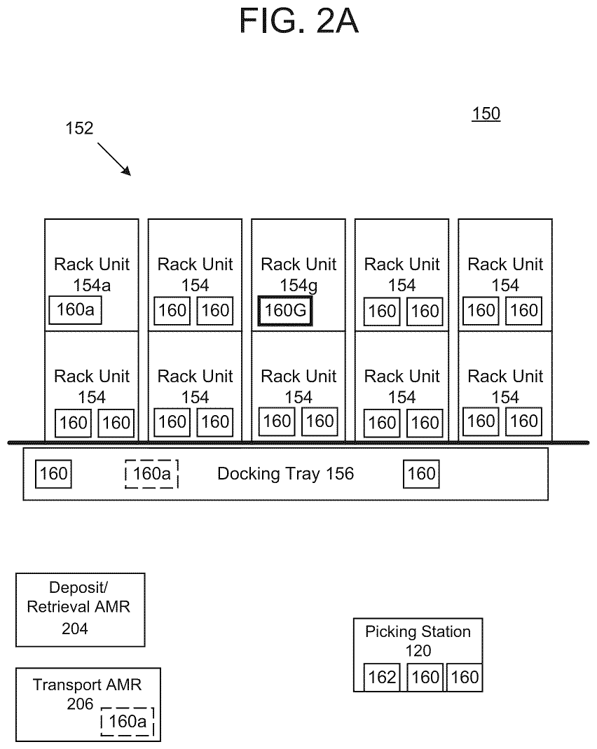

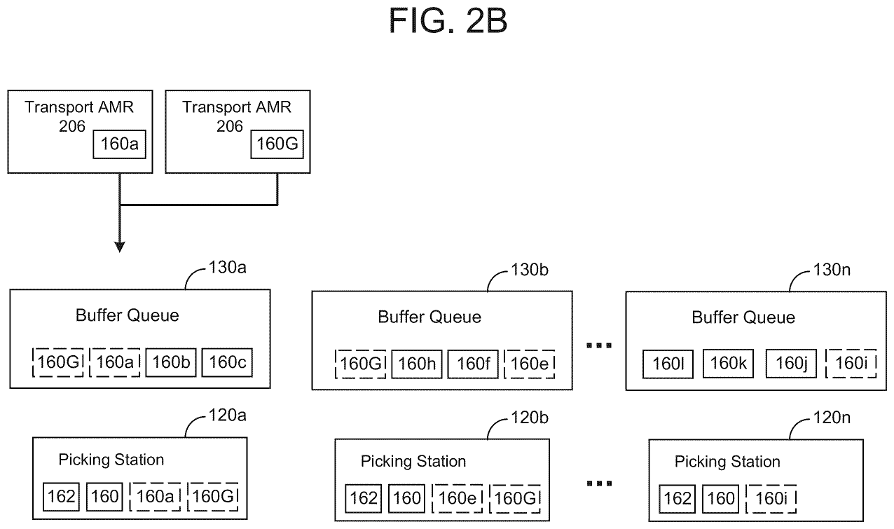

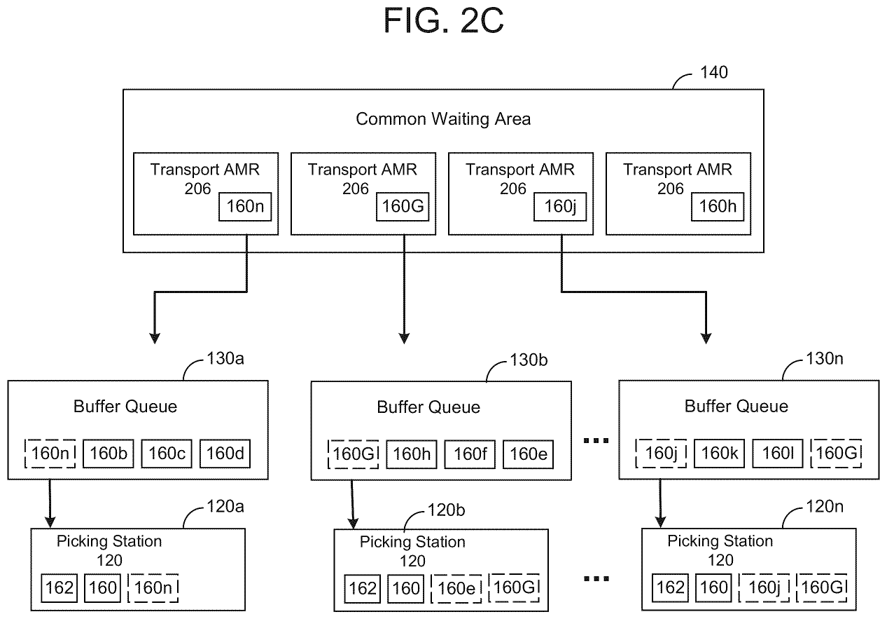

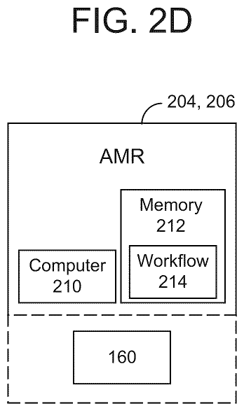

Referring to FIGS. 1 and 2, an exemplary order fulfillment system 100 includes a warehouse control system (WCS) 101 such as warehouse controller or orchestrator, a fulfillment control and monitoring system 102, a warehouse management system (WMS) 103, a warehouse execution system (WES) 104, and a supply chain management system 105. FIG. 2 illustrates an exemplary warehouse or storage facility 200 for order fulfillment, which is disclosed for use with control systems, e.g., the order fulfillment system 100, in accordance with aspects of the present invention. An exemplary warehouse environment 200 includes a variety of different agents 202, 204, 206. Each class of agents has distinct objectives and capabilities. The agents illustrated in FIG. 2 include pickers such as human pickers, humanoids 202, robotic pickers (also referred to as autonomous mobile robots (AMRs), or as retrieval/putaway AMRs (hereinafter “retrieval/putaway AMRs”) or quadruped) 204, and automated guided vehicles (AGVs) and/or quadruped, also referred to as transport bots or transport AMRs (hereinafter “transport AMRs”) 206, configured to carry items picked by the human pickers 202 and/or the retrieval/putaway AMRs 204. Alternatively, the AGVs may be substituted with AMRs configured for carrying and transporting the picked items. The overall logistics of the warehouse 200 would be distributed across the classes of agents 202, 204, 206. Additional agents would include fixed automation assets in the warehouse 200 as well as fulfillment management systems (e.g., WES, WCS, and WMS). The agents 202, 204, 206 are allocated and/or assigned to one or more order channels within the warehouse 200 (which are managed by the order fulfillment system 100 and the order management system 102).

The AMR vehicles 204, 206 are controlled and/or managed in the warehouse 200 by an AMR Robot Controls System (RCS) 107 (see FIGS. 1 and 2). The RCS 107 includes a software module adapted to maintain knowledge of the warehouse layout as well as the location and status of all of the AMR vehicles. As noted herein, the warehouse environment 200 includes a warehouse execution system (WES) 104, a warehouse control system (WCS) or warehouse management system (WMS) 103 that are responsible for order fulfilment in the warehouse 200 and overall control of inventory, respectively. It should be appreciated that each of the WES, WCS, and WMS, if present, may have unique, although potentially overlapping, responsibilities within the warehouse. However for clarity purposes, unless otherwise referenced by their specific name or acronym, the WES, WCS, and WMS are hereinafter referred to generally as the Warehouse Execution System (WES) 104. The WES 104 and the RCS 107 are in communication in order to move inventory about the warehouse 200 as required such as to maintain adequate stock of inventory in desired locations to support order fulfilment processes and/or to direct and conduct order fulfilment processes (e.g., picking). In one or more implementations, the RCS 107 can be integrated into and form a portion of the WES 104.

In traditional order fulfillment solutions utilizing AMRs 204, 206, the order fulfilment processes are implemented with the RCS 107 using a centralized “fleet manager,” which globally tracks, manages, directs, and assigns tasks to the entire fleet of AMRs 204, 206. For example, the fleet manager may manage and coordinates major functions of managing job requests, qualification, path/route planning, assignment of AMRs 204, 206 to regions of the facility, assignment of tasks to individual AMRs 204, 206, and run-time navigation & path rerouting for the AMRs 204, 206. The RCS 107 receives all work/task requests from the WES 104 for all work to be done by any of the AMRs 204, 206. The fleet manager then processes the work/task requests and assigns each of the AMRs 204, 206 a load movement task or tasks to perform. The WMS and/or WES 103, 104 are reliant on status updates from the AMRs (e.g. an AMR subsystem). For example, the WMS 103 and/or WES 104 send transport requests to the AMR subsystem and wait for status updates and completion confirmations to be returned by the AMR subsystem. Methods and systems of the exemplary embodiments provide for improved order fulfillment using AMRs and associated guidance systems. In one or more implementations, the WMS and/or WES 103, 104 can rely on status updates of the AMRs (e.g., an AMR subsystem) stored on a memory or the RCS 107.

In coordination with the RCS 107 and/or WES 104, exemplary AMRs 204, 206 are capable of self-selecting tasks and autonomous operation/navigation for order fulfillment activities related to assigned tasks. Each AMR 204, 206 in the facility is thus responsible and operable to self-select its own tasks from a pending task list provided by the WES 104. The AMR computer code (e.g., workflow 214 stored in memory 212, as depicted in FIG. 2D) is adapted to only select a task of which that particular AMR 204, 206 is capable of performing at a given time (i.e., a consideration of physical capability and logistical availability). The WES 104 includes a computer device that is programed with computer code that is adapted to maintain a pending workflow list made up of tasks, and optimized task lists or queues, to be performed within the material handling facility. For example, the tasks on the pending workflow list may include a material pick task in which the AMR 204, 206 must pick an item from a particular location within the material handling facility (e.g., a retrieval/putaway AMR 204), and a container retrieval task in which the AMR retrieves a particular container for receiving and retaining items (e.g., a transport bot 206 for receiving and transporting an item) (see FIG. 2). As another example, a material pick task may include picking an item from a particular location into a container on the AMR (e.g., a retrieval/putaway AMR 204 or transport AMR 206) (see FIG. 2D). While the AMR 204, 206 illustrated in FIG. 2D discloses only a single donor tote 160, two or more donor totes 160 may be arranged within the container of the AMR 204, 206.

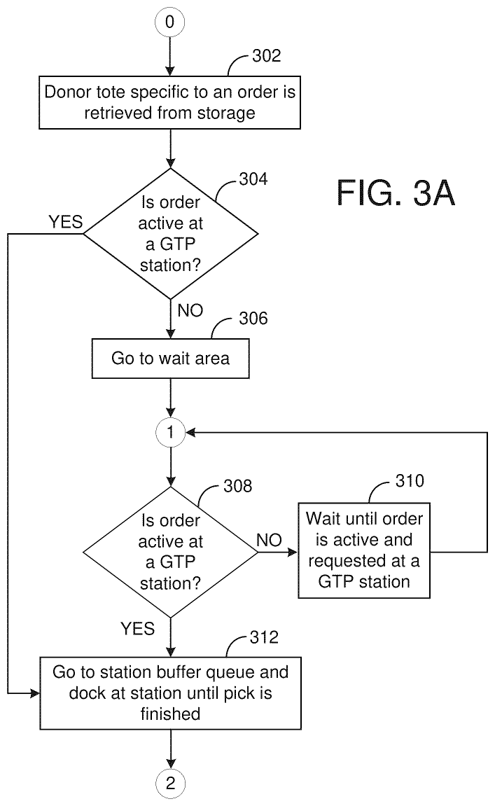

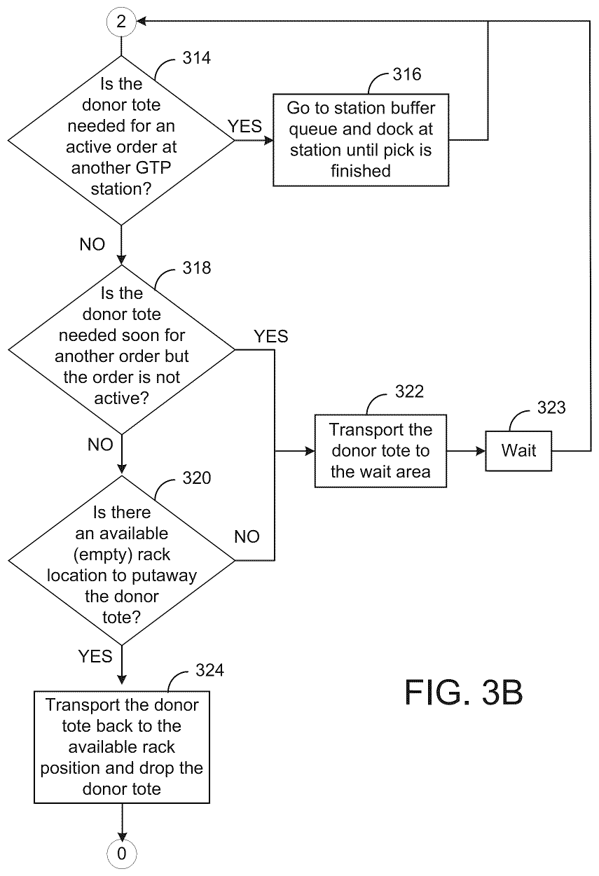

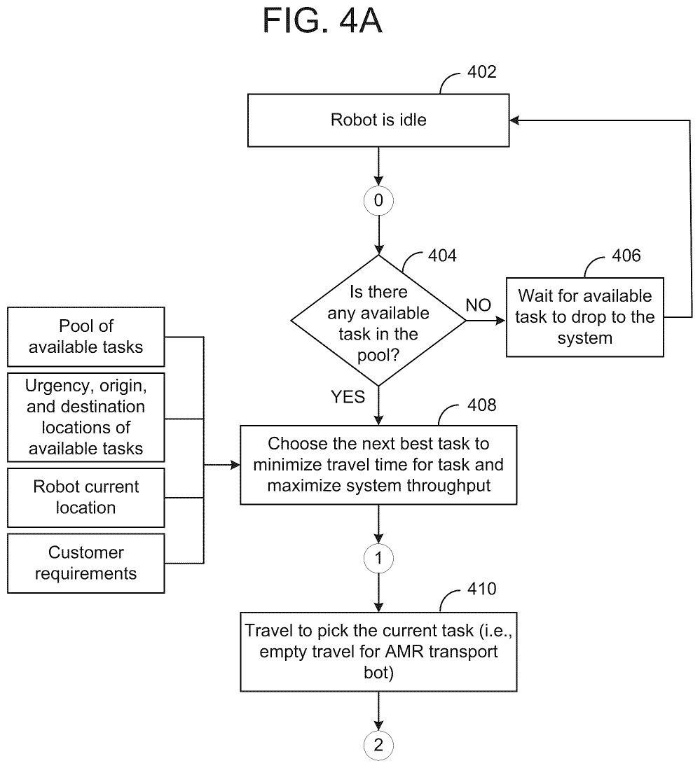

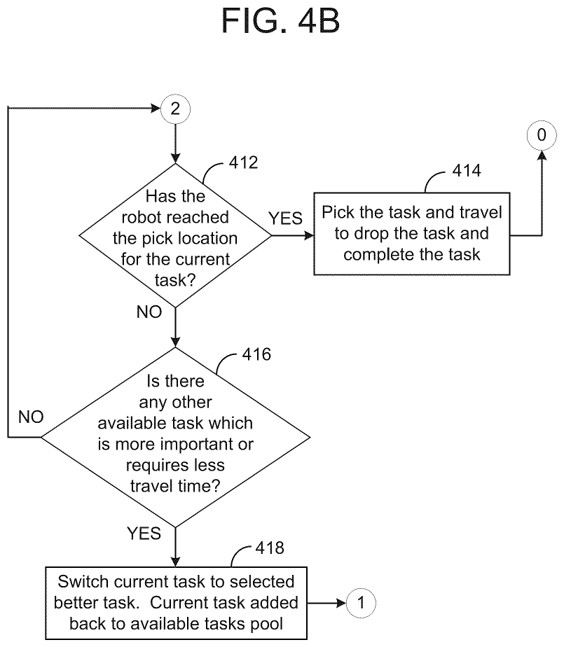

The computer device of the WES 104 may comprise one or more processors as well as hardware and software, including for performing the operations discussed herein. Each AMR 204, 206 includes an onboard robot operating system (ROS) operating upon an onboard computer device 210, which is in communication with the WES 104. As illustrated in FIG. 2D, the AMR onboard computers 210 may comprise one or more processors as well as hardware (e.g., a memory 212) and software (AMR workflow 214), including for performing the operations discussed herein. Each AMR onboard computer 210 is programmed with computer code including an AMR workflow 214 (FIGS. 3-4), such as including an algorithm or logic, that is adapted to dynamically select a task to perform from the assigned task queue (as provided or self-selected from the pending workflow list of the WES 104), and may maintain a pending task list of previously selected tasks for the AMR (i.e. an AMR workflow list).

The WES 104 maintains information for each of the tasks, including the coordinates to which an AMR 204, 206 must travel to complete a task, such as to may pick up loads. The WES 104 may maintain more than one job queue based on the workflow list, such as different job queues for different regions of the warehouse facility 200, with each job queues having a prioritized and optimally sequenced task list for tasks to be completed in the corresponding region. The job queues create different demand requirements per region to provide adequate AMRs 204, 206 to perform the tasks in a particular region.

The WES 104 may include a “next action” logic or algorithm that is configured to determine the most urgent task to be selected, and the next action logic may be integrated or linked with the AMRs onboard computers 210. Wherein, the next action logic can take into account each AMR's capabilities/capacity, current location, future location, and/or configurable parameters (in addition to other aspects or parameters) to select the most urgent tasks to be selected, prioritized, and sequenced in the WES workflow list to be accessed for task self-selection by the AMRs 204, 206. The WES 104 may include a “move” logic or algorithm that is configured to monitor and regulate the allocation of AMRs 204, 206 concurrently working in each region/area of the facility in order to balance AMR resources in an optimal manner and to reduce traffic congestion in the regions.

In an aspect of the present embodiment, the selecting of another task from a task queue (as provided from the prioritized/optimized/sequenced WES pending workflow list) includes determining with the AMR's onboard computer 210 whether the AMR 204, 206 has capacity to pick the material required for at least one of the remaining tasks of the task queue. If the AMR 204, 206 lacks capacity, the onboard computer 210 returns to determining whether the AMR 204, 206 has capacity to pick the material required for a different one of the remaining tasks on the task queue. If the AMR 204, 206 has capacity, the onboard computer 210 selects one of the tasks from the task queue for which it has capacity in order to evaluate whether that selected task is an optimal or advantageous task for the AMR 204, 206 to undertake at the current iteration. After the onboard computer 210 selects or is assigned a task queue, the onboard computer 210 of the AMR 204, 206 may evaluate whether a particular task from the task queue, is an optimal or advantageous task for the AMR 204, 206 to undertake, such as based on the current location or capacity of the AMR 204, 206. In this manner, the AMR 204, 206 may continuously prioritize, optimize, and sequence the tasks on the task queue assigned to that AMR 204, 206. The onboard computer 210 may select the most optimal task remaining on the task queue. If the AMR 204, 206 is not within sufficiently close proximity of the selected task, the onboard computer 210 returns to determining whether the AMR 204, 206 has capacity to pick the material required for a different one of the tasks remaining on the task queue. If the AMR 204, 206 is within sufficiently close proximity of the selected task, the onboard computer 210 adds the task to the dynamic workflow list of the AMR workflow 214 and subsequently controls the AMR 204, 206 to perform the selected task. Upon completion of the selected task, the AMR workflow 214 may determine whether the AMR 204, 206 has capacity to pick the material required for at least one of the tasks remaining on the task queue. It is contemplated that more or fewer of the evaluation functions described above may be computed or determined by the AMR onboard computer 210, independent of the WES 104, thereby further reducing the computing requirements and strain on the WES 104, for example. It is also contemplated that more or fewer of the tasks and functions performed by the WES 104 and/or more or fewer of the tasks and functions performed by the onboard computer 110 of the AMR 104 may be handled or performed by the other of the WES 104 or AMR onboard computer 210, or optionally the WES 104 and AMR onboard computer 210 may coordinate to perform some of such tasks and functions, for example.

Referring to FIG. 2A, an exemplary goods-storage and order-fulfillment system 100 includes a rack store 150 consisting of rack units 154, which can be freely stacked on placement surfaces, more particularly on a floor, stage surfaces, or other surfaces. The rack units 154 can be arranged to form at least one multi-level shelving rack 152 and provide the rack store 150 (i.e., the rack store 150 includes one or more multi-level shelving racks 152). The multi-level shelving rack 152 is configured as an arrangement of stackable shelving racks 154, with each shelf of the stackable shelving racks 154 configured for use to store one or more donor totes 160 containing articles for order fulfillment activities at an eventual workstation or picking station 120 (thus, orders may be fulfilled into order totes 162). In addition, a docking tray 156 is positioned below each of the multi-level shelving racks 152 for the temporary storage of donor totes 160. In one or more implementations, a second or more docking trays above the docking tray 156 can be positioned on higher levels of the multi-level shelving racks 152. As illustrated in FIG. 2A, an exemplary autonomous mobile retrieval/putaway robot (hereinafter a “retrieval/putaway AMR”) 204 is configured for depositing the donor totes 160 into respective rack units 154 of a multi-level shelving rack 152. The retrieval/putaway AMR 204 is also configured for retrieving donor totes 160 from the rack units 154 (for order fulfillment or other inventory management activities). Thus, an exemplary deposit/retrieval robot 204 is an autonomous mobile robot moving from shelving rack 154 to shelving rack 154 to deposit and/or retrieve donor totes 160. FIG. 2A also illustrates an exemplary autonomous mobile transport robot (hereinafter a “transport AMR”) 206, which is configured for receiving donor totes 160 from or transferring donor totes 160 to the retrieval/putaway AMR 204 in order to transport a donor tote 160 to a picking station 120 or to transfer a donor tote 160 to a docking tray 156. An exemplary picking station 120 is supplied with donor totes 160 by a transport AMR 206 for at least partial order fulfillment on the basis of order data.

Referring to FIGS. 2 and 2A, an exemplary warehouse 200 includes a bin-to-picker solution where goods/articles are stored in donor totes 160 on the shelves of shelving racks 154 within a rack store 150 or similar storage area. The donor totes 160 can be deposited and retrieved from the shelving racks 154 by a retrieval/putaway AMR 204. The retrieval/putaway AMR 204, after proper positioning, can retrieve a selected donor tote 160a from a shelving rack 154a and position the selected donor tote 160a onto a docking tray 156 below the multi-level shelving rack 152. The docking tray 156 provides temporary storage for such donor totes 160. A transport AMR 206 can then pick up the donor tote 160a from the temporary storage position on the docking tray 156 and transport the tote 160a to a picking station 120. As illustrated in FIG. 2B, the selected donor tote 160a is then placed into a buffer queue 130a (associated with a particular picking station 120a) when the selected donor tote 160a arrives at the picking station 120a. As illustrated in FIG. 2B, the newly arrived donor tote 160a is placed into the buffer queue 130a, which already contains donor totes 160b and 160c. Note that each donor tote 160a, 160b, and 160c waiting in the buffer queue 130 is still carried by an associated transport AMR 206 (not illustrated for the sake of clarity). Thus, the totes positioned within a buffer queue are understood to be carried by a transport AMR 206.

The donor totes 160a-160c (and their associated transport AMRs 206) in the buffer queue 130a may need to be rearranged in the queue 130a based on the sequence of activated orders at the picking station 120a. Such rearrangement of the donor totes 160a-160c (and their associated transport AMRs 206) can cause congestion in the picking station area (i.e., the picking station 120a and the buffer queue 130a). For example, while donor tote 160c is the next tote to be removed from the buffer queue 130a, the picking station 120a may need donor tote 160b to fill a current, activated order. The need to rearrange the totes (to retrieve the needed donor tote 160b) causes congestion around the buffer queue 130a and picking station 120a (as the transport AMRs 206 reposition their respective donor totes 160). As a result, the current active order will take longer to complete.

Certain donor totes 160, referred to as “golden totes” (e.g., a donor tote 160G), contain goods that are picked more frequently than others and multiple orders may compete for the same donor tote 160G (i.e., the golden tote). Rack unit 154g holds a donor tote 160G, which is needed at both picking station 120a and picking station 120b (see FIG. 2B). As illustrated in FIG. 2B, each buffer queue 130 contains donor totes 160 (and their transport ARMs 206) as well as expected donor totes to meet expected orders at the picking station 120. For example, picking station 120a is picking from tote 160 into tote 162, while also expecting tote 160a and the golden tote 160G (the tote 160a and golden tote 160G are expected at the associated buffer queue 130a). As illustrated in FIG. 2B, transport AMRs 206a and 206b are carrying the donor tote 160a and the golden tote 160G, respectively. As also illustrated in FIG. 2B, the golden tote 160G is also needed at picking station 120b (and expected at buffer queue 130b). The need to transport the golden tote 160G back to the storage 150 from the picking station 120a (after order fulfillment) would cause other orders with demand for that same donor tote 160G (e.g., picking station 120b) to be blocked, resulting in those orders taking more time to complete.

Conventionally, when the goods have been picked at the particular picking station 120 (e.g., picking station 120a), the donor tote 160G would be transported back to the rack store 150 and placed in an empty docking tray 156 (for placement into a rack unit 154). When later retrieved again and transported back to the next picking station 120 (e.g., picking station 120b), the donor tote 160G must then wait at the associated buffer queue 130 (e.g., buffer queue 130b) until there is a position open at the picking station 120b, which causes congestion at the picking station 120b and the picking operator is blocked from performing the next picking action. As illustrated in FIG. 2B, the warehouse 200 includes a plurality of picking stations 120a-120n each with a respective buffer queue 130a-130n. As discussed herein, exemplary transport AMRs 206 deliver totes 160 to selected buffer queues 130a-130n and their respective picking stations 120a-120n.

### Common Waiting Area

Referring to FIG. 2C, an exemplary independent or common waiting area 140 receives donor totes 160 (and their transport AMRs 206) regardless of their eventual picking station 120a-120n. Such donor totes 160 and their transport AMRs 206 can be temporarily staged (at the common waiting area 140) before being transported to the requesting picking station 120a-120n or back to the storage area 150. Sequencing orders at a pick station 120a-120n includes a common waiting area 140 independent of the pick stations 120 for staging the transport AMRs 206 and their cargo (the donor totes 160). Note, upon delivering a next donor tote 160 to the waiting work station 120a-120n, the transport AMR 206 (holding the donor tote 160) will deliver the tote 160 either to the picking station 120-120n, or to the associated buffer queue 130a-130n. By ordering the delivery of donor totes 160 at the picking stations 120a-120n, the donor totes 160 (and their respective transport AMRs 206) will not need to be reordered when placed into a buffer queue 130a-130n.

Referring to FIGS. 2C, 3A, and 3B, an exemplary method for sequencing orders at a picking station 120 (e.g., picking station 120a) that includes an association with a common waiting area 140 associated with the picking stations 120a-120n, includes retrieving the donor totes 160 for specific orders. As those donor totes 160 (and their transport AMRs 206) for specific orders are arriving for their respective picking stations 120a-120n, the donor totes 160 are placed into the common waiting area 140. For example, donor totes 160n, 160j, 160h, and 160G (a golden tote) are retrieved from the storage area 150 (using an exemplary retrieval/putaway AMR 204) and delivered via transport AMRs 206 to the common waiting area 140 (in no particular order). The donor totes 160n, 160j 160h, and 160G of the one or more orders are placed into the common waiting area 140 before the order(s) are activated at specific picking stations (e.g., picking stations 120a, 120b, and 120n).

When an order is active at a picking station 120a, the first donor tote of the order (e.g., donor tote 160n) is transported to the specific picking station 120a to perform the pick operations. The donor tote 160n may be delivered directly to the picking station 120a or to the associated buffer queue 130a (such that the totes are arranged in proper order in the buffer queue 130 and thus avoiding the necessity of rearranging the totes for delivery to the picking station 120). When the picking order (from donor tote 160n) is completed at the picking station 120a, the RCS 107 or WES 104 will determine if the donor tote 160n is needed for an immediate picking operation at another picking station 120 (e.g., picking station 120b). If yes, the donor tote 160n is transported directly to the next picking station 120 (e.g., picking station 120b). If not, the RCS 107 and/or WES 104 will determine if there are available rack positions 154 in the storage area 150 for putaway of the donor tote 160n. If yes, the donor tote 160n will be transported to the available rack position 154 for putaway. If not, the donor tote 160n will be transported to the common waiting area 140 until there is a rack position 154 available or if the donor tote 160n is needed at another picking station 120 (e.g., picking station 120c). As illustrated in FIG. 2C, the common waiting area 140 is currently holding donor tote 160n, golden tote 160G, donor tote 160j, and donor tote 160h. Note that golden tote 160G is requested by picking station 120b. When a next available space is opened in buffer queue 130b, donor tote 160h will be delivered to the buffer queue 130b.

A more flexible assignment of AMRs 206 (and their donor tote cargo) to picking stations 120a-120n allows for less strict sequencing of the donor totes 160 and the orders. There is no need to reorder the transport AMRs 206 (and their donor totes 160) in the buffer queues 130, which potentially can avoid congestion around the picking station 120. Other benefits include better work allocation across the various picking stations 120a-120n. The assignment decision of an order at a picking station 120a-120n could be postponed to the common waiting area 140. This gives the opportunity to make last minute changes depending on a current state of the system 100. As described herein, such decisions can be made by the individual AMRs 206, the WES 104, and/or the RCS 107. The common waiting area 140 also takes care of the “Golden Tote Problem” (i.e., multiple orders competing for the same donor tote) by using the common waiting area 140 as a tentative or temporary storage location until the donor tote 160G is needed for another picking station 120 (e.g., picking station 120n) (see FIG. 2D). The use of the common waiting area 140 also allows for immediate release at picking stations 120a-120n so that the operator can start picking the next order as soon as possible, assuming there is a logic that controls the available capacity at the common waiting area 140 so that the common waiting area 140 does not run out of capacity. For example, the common waiting area 140 may have the capacity for twenty (20) transport AMRs 206, each with the room for independent maneuvering and entry/exit. The capacity can be higher or lower. Whatever the capacity, in one exemplary embodiment, a preselected portion of the total capacity is reserved for golden totes 160G.

Referring to FIGS. 3A and 3B, in step 302 of FIG. 3A, a donor tote 160 specific to an order is retrieved from storage 150. In step 304 of FIG. 3A, a determination is made as to whether the order is active at a picking station 120. If the order is not active at a picking station 120, in step 306 of FIG. 3A, the donor tote 160 is moved to the common waiting area 140. However, if the order is active at a picking station 120 (e.g., picking station 120a), then in step 312 of FIG. 3A, the donor tote 160 is delivered to the picking station's buffer queue 130 (e.g., buffer queue 130a) for eventual docking at the picking station 120a until the pick is finished. After completing step 312 of FIG. 3A, the method continues through “node 2” on the way to step 314 of FIG. 3B. After the donor tote 160 is delivered to the common waiting area 140 in step 306 of FIG. 3A (to wait because the order is not yet active at a picking station 120), the method passes through “node 1” on the way to step 308 of FIG. 3A. In step 308 of FIG. 3A, a determination is made as to whether the order is now active at a picking station 120. If the order is still not active at the picking station 120, then in step 310 of FIG. 3A, the donor tote 160 waits in the common waiting area 140 until the order is active at a particular picking station (e.g., picking station 120a). Note, in addition to waiting in the common waiting area 140 until the order is active at a particular picking station, the donor tote 160 will wait until instructed to present its load at the selected picking station, and continues back to “node 1” of FIG. 3A.

The method continues from “node 2” and continues with step 314 of FIG. 3B, where a determination is made as to whether the donor tote 160 is needed for an active order at another picking station 120 (e.g., picking station 120b). If yes, then in step 316 of FIG. 3B, the donor tote 160 is delivered to the picking station's buffer queue 130b for eventual docking at the picking station 120b until the pick (from the donor tote 160) is finished. The method continues back to step 314 of FIG. 3B.

If the donor tote 160 is not needed for an activate order at another picking station 120 in step 314 of FIG. 3B, then the method continues to step 318 of FIG. 3B. In step 318 of FIG. 3B, a determination is made as to whether the donor tote 160 will be needed within a threshold period of time, when the order is not currently active? If yes (at step 318 of FIG. 3B), the method continues to step 322 of FIG. 3B, if no (at step 318 of FIG. 3B), the method proceeds to step 320 of FIG. 3B. In step 322 of FIG. 3B, the donor tote is transported to the common waiting area 140, where the donor tote will wait (via step 323 of FIG. 3B) until the method continues back to step 314 again (via “node 2”).

In step 320 of FIG. 3B, a determination is made as to whether there is an available rack location 154 in the storage area 150 to put away the donor tone 160. If there is an available rack location 154 in the storage area 150, the method continues to step 324 of FIG. 3B and the donor tote is transported back to the available rack location 154 and dropped off. If there is not an available rack location 154 in the storage area 150 (at step 320 of FIG. 3B), the method continues back to step 322 of FIG. 3B and the donor tote is transported to the common waiting area 140 for temporary storage as discussed herein.

### Dynamic Task Selection for AMRs

Existing solutions for determining a next task for an AMR (a transport AMR 206 or a retrieval/putaway AMR 204) are based on a central task assignment where the next task for a certain AMR is determined in a central management system. Such a push system (for task assignment) is cumbersome and lacks the flexibility required for an autonomous robot (i.e., an AMR, such as a transport AMR 206 or a retrieval/putaway AMR 204) to function independently. A central task assignment system typically requires large and potentially time consuming calculations to be done which negatively impacts the performance of the system. This results in congestion and unnecessary empty travel time which have a negative effect on the order fulfillment throughput.

In an exemplary embodiment of the present invention, an exemplary solution includes the introduction of distributed on-demand task assignment where the AMRs 204, 206 each select an optimal next task from a set of available tasks (provided by the WES 104 and/or RCS 107). As illustrated in FIG. 2D and discussed herein, each AMR 204, 206 includes an onboard robot operating system (ROS) operating upon an onboard computer device 210, which is in communication with the WES 104. As illustrated in FIG. 2D, the AMR onboard computers 210 may comprise one or more processors as well as hardware (e.g., a memory 212) and software (AMR workflow 214), including for performing the operations discussed herein. Each AMR onboard computer 210 is programmed with computer code including an AMR workflow 214 (FIGS. 3-4), such as including an algorithm or logic, that is adapted to dynamically select a task to perform from the assigned task queue (as provided or self-selected from the pending workflow list of the WES 104), and may maintain a pending task list of previously selected tasks for the AMR (i.e. an AMR workflow list).

Such a task selection is based on an on-demand task assignment and allows the particular transport AMR 206 or retrieval/putaway AMR 204 to select a most suitable next task for itself according to its own AMR workflow 214. As described herein, the next optimal task for a particular AMR is based upon the AMR's current location in the warehouse 200, the location and urgency of the available tasks, and other business or customer rules (if any). Such assessment criteria helps to minimize the required travel time to perform the task and maximizes the throughput of the system 100 with a goal to satisfy the customers' requirements.

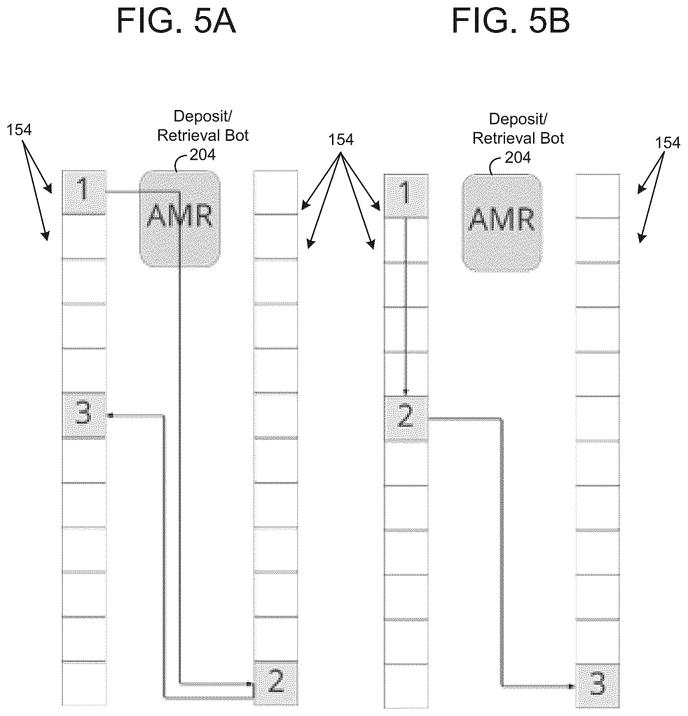

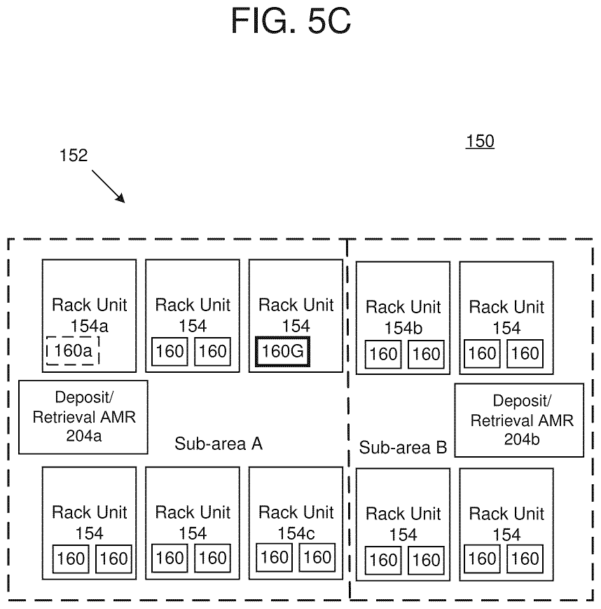

When the AMR 204, 206 is about to complete the current allocated task (e.g., within a selected period of time before task completion), the AMR 204, 206 will either access a list of available tasks or ask for available tasks to choose from (e.g., from the WES 104 and/or the RCS 107). The AMR 204, 206 will select the next task based on the travel time needed to perform the task, the urgency of available tasks, and other business or customer rules (if any). While the AMR 204, 206 is travelling to the pick position for the next task, the AMR 204, 206 is re-evaluating the list of available tasks to determine if there are any available tasks that are (or have become) more important or require less travel time. If the AMR 204, 206 determines that there is a better alternative task to perform, the AMR 204, 206 will switch to that task. The task that was unselected will then be added back to the list of tasks available for other AMRs 204, 206 to perform. This re-evaluation process is illustrated in FIGS. 4A and 4B, beginning at node 2 until the AMR 204, 206 reaches the pick position of the current allocated task. Once the AMR 204, 206 reaches the pick position of the current task, it will perform the required picking for the current task and then travel to the drop position and complete this task. For example, as illustrated in FIGS. 2A and 5C, an exemplary retrieval/putaway AMR 204 will travel to a particular location within the storage area 150 to perform a retrieval operation to retrieve a selected donor tote 160 that is then placed upon an empty position on the docking tray 156. After dropping off the donor tote 160, the retrieval/putaway AMR 204 checks for the available tasks in the set of available tasks to choose a next task to perform (returning to node 0 of the method).

As illustrated in FIGS. 4A and 4B, in step 402 of FIG. 3A, an AMR (e.g., a transport AMR 206 or a retrieval/putaway AMR 204) is in an idle state and ready for a next task. The method proceeds through “node 0” and in step 404 of FIG. 4A checks for a next task to perform in a pool of available tasks. Such a pool of available tasks may also be referred to as a task queue or a list of tasks. If there are no available tasks to perform (for a particular AMR 204, 206), then the AMR 204, 206 will wait a period of time in step 406 and return to the idle state in step 402 of FIG. 4A.

If in step 404 of FIG. 4A there are available tasks in the list of tasks for the AMR to perform, the method proceeds to step 408 of FIG. 4A, where a next best task will be chosen. Such choice is based upon a minimization of travel time and maximizing order fulfillment throughput. Leaving step 408 of FIG. 4A, and passing through “node 1,” the method continues to step 410 of FIG. 4A and the AMR 204, 206 travels to the current task. For example, for an transport AMR 206, the transport AMR 206 will travel empty. The method passes through “node 2” and proceeds to step 412 of FIG. 4B.

In step 412 of FIG. 4B, a determination is made as to whether the AMR 204, 206 has reached the pick location for the current task. If the AMR 204, 206 has reached the pick location, then in step 414 of FIG. 4B, the AMR 204, 206 will complete any travel or movement to complete the tasks (dropping off product, etc.) to complete the task. After completing the task, the method continues back to “node 0” and the AMR 204, 206 will be idle and ready to search for a next task. If in step 412 of FIG. 4B, the AMR 204, 206 has not reached the pick location, the method will continue to step 416 of FIG. 4B and a determination is made as to whether there are any other available tasks which are more important or requires less travel time. If a determination is made that there are not any other more important or closer available tasks, the method continues back to “node 2” and back to step 412 of FIG. 4B. If there is another task that is either more important or requires less travel time (than a current task), then the method continues to step 418 of FIG. 4B. In step 418 of FIG. 4B, the current task is switched out for the selected “better” task. The current task to be dropped is added back to the list of available task. Thus, those AMRs 204, 206 can consider taking the dropped task as a next task. After taking up the selected better task, the method continues on to “node 1” and returns to step 410 of FIG. 4A.

### Smart Task Assignment for Putaway and Retrieval Tasks in a Storage Area

An AMR for putaway and retrieval (e.g., a retrieval/putaway AMR 204) tasks can be assigned a sequenced list of putaway or retrieval tasks. The sequence of the tasks may be determined according to a pre-defined set of conditions carried out by the AMR's workflow 214, which is adapted to self-select tasks to execute from the lists or queues of tasks (such lists of tasks may also include lists of tasks that have been assigned to a particular AMR 204, 206). Each putaway or retrieval task requires the retrieval/putaway AMR 204 to move to a certain position in the storage area 150 to perform the requested putaway or retrieval task. Nonessential horizontal movement of the retrieval/putaway AMR 204 in the storage area 150 has a negative effect on efficiency and productivity (see FIGS. 5A and 5B). Depending on the tasks in the sequence of tasks (and their arrangement), horizontal movement of the retrieval/putaway AMR 204 down the aisle, as well as left-right movement from one side of the aisle to the other may be necessary, which causes unnecessary travel time and may also cause congestion in the storage area 150.

In an exemplary embodiment illustrated in FIGS. 5A, 5B, and 5C, the apparatus and associated method provides for the optimized task assignment of putaway and retrieval tasks that allows each retrieval/putaway AMR 204 to select and perform tasks from a queue or list of tasks instead of performing the tasks in a predetermined sequence. For example, each retrieval/putaway AMR 204 of a plurality of retrieval/putaway AMRs is assigned a dynamic list of tasks requiring putaway or retrieval actions at various positions (horizontally, vertically, and left/right) in the storage area 150. The individual tasks in the assigned queue/list of tasks can be performed in any arbitrary order, with no specific sequence required.

When the retrieval/putaway AMR (e.g., retrieval/putaway AMR 204a) has completed a task at a position within the storage area 150 (e.g., rack unit 154a), the retrieval/putaway AMR 204a will select a next task from the assigned queue/list of tasks based on a set of boundary criteria to optimize travel time and balance between putaway and retrieval tasks. For example, rather than selecting a retrieval task at rack unit 154b (which would cause the retrieval/putaway AMR 204a to cross the isle and potentially conflict with or obstruct retrieval/putaway AMR 204b, the retrieval task at rack unit 154c will be selected. Examples of selection criteria include any of the following:
Selection incorporates the number of pending retrievals or putaways and tries to balance pending retrievals versus putaways.
Selection depends on the current location of the autonomous retrieval/putaway AMR 204 and locations of the assigned list or queue of tasks for the retrieval/putaway AMR 204. Given other constraints are satisfied, the next task from the assigned list or queue of tasks can be selected to minimize horizontal travel. For example, as illustrated in FIGS. 5A and 5B, supposing tasks 1, 2, and 3 shown in FIG. 5A become available in that sequence. If the retrieval/putaway AMR 204 follows that sequence to execute the assigned tasks, the retrieval/putaway AMR 204 will need to travel 1.5 times longer than the distance if the retrieval/putaway AMR 204 had chosen the next task to minimize the horizontal travel (as illustrated in FIG. 5B).
Selection depends on the current location of the retrieval/putaway AMR 204 and the locations of the assigned group of assigned tasks as well as other criteria to keep the system feeding. For example, if the current location of the retrieval/putaway AMR 204 is closer to a rack 154a with a load waiting for putaway, do the putaway task if there is at least “X” number of loads carried by the retrieval/putaway AMR 204 for deposit at or around the rack 154a position. This check is to make sure that the retrieval/putaway AMR 204 does not make the retrieval/putaway AMRs 204 starve for outbound work for the sake of minimizing travel along the aisle.

The assigned list of tasks may also be assigned using an order management system with a bubble manager using a sliding bubble algorithm for order release and material management. Exemplary bubble algorithms include revolving bubble algorithms, sliding bubble algorithms, and the slide bubble with strict sequencing regarding the arrival of articles at the designation. Whatever the bubble algorithm used, the algorithm aids in sorting the available tasks into queues or lists of tasks. The systems and methods of the present disclosure may include or utilize structure, function, and/or processes (such as for order prioritization and sequencing at the WES 104, e.g. sliding bubble approach) such as those disclosed in commonly owned and assigned U.S. Patent Applications Pub. No. 2022/0106121A1, published Apr. 7, 2022 and entitled SYSTEM AND METHOD FOR ORDER FULFILLMENT SEQUENCING AND FACILITY MANAGEMENT, Pub. No. 2022/0245583A1, published Aug. 4, 2022 and entitled AUTOMATED ORDER FULFILLMENT WITH OPPORTUNISTIC DECANT OPERATIONS, and Pub. No. 2022/0309447A1, published Sep. 29, 2022 and entitled AUTONOMOUS MOBILE ROBOT BASED MATERIAL MOVEMENT SYSTEM AND METHOD, each by Dematic Corp. of Grand Rapids, MI, the disclosures of which are hereby incorporated herein by reference in their entireties. Systems and methods may be adapted (such as for order prioritization and sequencing at the WES 104 and/or at each individual, self-selecting AMR 204, 206, e.g. sliding bubble approach) from those disclosed in commonly owned and assigned U.S. Pat. No. 10,618,736, issued Apr. 14, 2020, and No. 10,882,696, issued Jan. 5, 2021, each to Dematic Corp. of Grand Rapids, MI, the disclosures of which are hereby incorporated herein by reference in their entireties. Such methods also include collaboration between multiple retrieval/putaway AMRs 204 in a defined storage area 150 (see FIG. 5C). The retrieval/putaway AMRs 204 split the defined parts into sub-areas where each retrieval/putaway AMR 204 is assigned one sub-area such that the cooperating retrieval/putaway AMRs 204 avoid blocking each other and avoid congestion. As illustrated in FIG. 5C, retrieval/putaway AMR 204a is assigned to sub-area A, while retrieval/putaway AMR 204b is assigned to sub-area B. The exemplary sub-areas are not drawn to scale. The sub-area division can also change dynamically depending on the location of the assigned tasks for each retrieval/putaway AMR 204.

The advantages of coordinating the operations of multiple retrieval/putaway AMRs 204 include any of the following:
A reduced need for horizontal movement in the storage area 150.
An increased throughput in retrieval and putaway tasks.
A reduced need for empty travelling of retrieval/putaway AMRs 204.
A reduced congestion in the storage area 150.
A reduction in waiting times for the retrieval/putaway AMRs 204.

As previously described, a computer system described with reference to the figures herein may generally comprise a processor, an input device coupled to the processor, an output device coupled to the processor, and memory devices each coupled to the processor. The processor can perform computations and control the functions of the system, including executing instructions included in computer code for the tools and programs capable of implementing methods for monitoring warehouses, distribution centers, and intralogistics, in accordance with some embodiments, wherein the instructions of the computer code can be executed by the processor via a memory device. The computer code may include software or program instructions that may implement one or more algorithms for implementing one or more of the foregoing methods. The processor executes the computer code.

The onboard computer, a processor integrated into the RCS, or a virtual processor formed as a portion of the WES, can be any processor such as a digital signal processor (DSP), a general purpose core processor, a graphical processing unit (GPU), a computer processing unit (CPU), a microprocessor, an AI processing unit, a crypto-processor unit, a neural processing unit, a silicon-on-chip, a graphene-on-chip, a neural network-on-chip, a neuromorphic chip (NeuRRAM), a system on a chip (SoC), a system-in-package (SIP) configuration, either single-core or multi-core processor, or any suitable combination of components.

The memory device may include input data. The input data includes any inputs required by the computer code. The output device displays output from the computer code. A memory device may be used as a computer usable storage medium (or program storage device) having a computer-readable program embodied therein and/or having other data stored therein, wherein the computer-readable program comprises the computer code. Generally, a computer program product (or, alternatively, an article of manufacture) of the computer system may comprise said computer usable storage medium (or said program storage device).

As will be appreciated by one skilled in the art, the disclosure may be a computer program product. Any of the components of the embodiments of the disclosure can be deployed, managed, serviced, etc. by a service provider that offers to deploy or integrate computing infrastructure with respect to embodiments of the inventive concepts. Thus, an embodiment of the disclosure discloses a process for supporting computer infrastructure, where the process includes providing at least one support service for at least one of integrating, hosting, maintaining and deploying computer-readable code (e.g., program code) in a computer system including one or more processor(s), wherein the processor(s) carry out instructions contained in the computer code causing the computer system for generating a technique described with respect to embodiments. In another embodiment, the disclosure discloses a process for supporting computer infrastructure, where the process includes integrating computer-readable program code into a computer system including a processor.

Aspects of the disclosures are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative and exemplary embodiments of the present invention provide a method and system in which AMRs are substantially independent, i.e., not reliant on an external or remote robot control system, to select tasks to perform within a material handling facility. The method enables AMRs to self-select tasks to perform. Onboard computers 210 of the AMRs 204, 206 are adapted to communicate with a WES 104 and using a workflow 214, to self-select a task to perform from the pending workflow list (e.g. a task queue) provided or maintained at the WES 104. In this manner, the AMRs are configured for self-selection of tasks and independent operation. The order fulfillment system 100 includes picking stations 120 with respective buffer queues as well as a common waiting area that is shared among a plurality of picking stations 120 to aid in optimal AMR arrangements and queuing of AMRs. In addition to the self-selection of tasks, the AMRs (e.g., retrieval/putaway AMRs 206) may be assigned to reserved sub-areas of the warehouse 200.

Changes and modifications in the specifically described embodiments can be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. An automated material handling system having a plurality of autonomous mobile robots (AMRs) for retrieving, transporting, and delivering items to and from locations within a material handling facility, said material handling system comprising:
a plurality of picking stations, each configured for picking operations as part of order fulfillment activities in the material handling facility; and
a common waiting area associated with at least a subset of said plurality of picking workstations, wherein said common waiting area is configured to provide temporary holding spaces for each associated picking workstation, wherein said common waiting area is configured to provide a temporary holding space for a first AMR of said plurality of AMRs when transporting items for order fulfillment activities at a first picking station that is not ready to receive the first AMR and its items;
wherein the first picking station is operable to send a prompt to the first AMR when ready for the first AMR and its items; and
wherein the first AMR is configured to leave said common waiting area and proceed to the first picking station when prompted by the first picking station.

2. The automated material handling system of claim 1, wherein each picking station of said plurality of picking stations comprises a respective buffer queue, each configured to provide a queue space for a selected quantity of AMRs of said plurality of AMRs with items for their respective picking stations of said plurality of picking stations.

3. The automated material handling system of claim 2, wherein each said buffer queue is configured to arrange up to a selected quantity of AMRs of said plurality of AMRs into a first-in, first-out queue, such that a first AMR of said plurality of AMRs to enter a buffer queue will be the first to leave the buffer queue.

4. The automated material handling system of claim 1, wherein said common waiting area comprises a plurality of temporary holding spaces for AMRs of said plurality of AMRs up to a selected quantity of the AMRs.

5. The automated material handling system of claim 4, wherein each temporary holding space of said plurality of temporary holding spaces is configured to provide a location for an AMR of said plurality of AMRs to wait until its destination is ready to receive it.

6. The automated material handling system of claim 1 further comprising a storage area configured to store items in donor totes for order fulfillment, wherein said plurality of AMRs comprises a first subset of AMRs comprising a plurality of deposit/retrieval AMRs each configured to deposit or retrieve donor totes with items to or from the storage area, wherein said plurality of AMRs comprises a second subset of AMRs comprising a plurality of transport AMRs each configured to transport items from location to location, and wherein each of said plurality of deposit/retrieval AMRs is configured to receive or deliver items to or from each of said plurality of transport AMRs.

7. The automated material handling system of claim 1 further comprising a warehouse control system configured to direct ones of said plurality of AMRs into said common waiting area, and further configured to release ones of said plurality of AMRs waiting in said common waiting area to continue on to their respective destinations.

8. A method of task allocation for a material handling system having a plurality of autonomous mobile robots (AMRs) for retrieving, transporting, and delivering items to and from locations within a material handling facility, said method comprising:
retrieving, with an AMR of the plurality of AMRs, a first donor tote specific to an order;
delivering, with the AMR, the first donor tote to a waiting area when the order is not active at a picking station;
delivering, with the AMR, the first donor tote to a first picking station when the order is active at the first picking station.

9. The method of claim 8, wherein the waiting area is a common waiting area and provides AMR waiting spaces for each of a plurality of associated picking stations.

10. The method of claim 8 further comprising:
removing, with the AMR, the first donor tote from the first picking station when picking from the first donor tote is complete; and
delivering, with the AMR, the first donor tote to a second picking station when the order is active at the second picking station.

11. The method of claim 10 further comprising delivering, with the AMR, the first donor tote to the waiting area when the order is not active at the second picking station but will be active within a threshold period of time, wherein the AMR with the first donor tote remains at the waiting area until the order is active at the second picking station.

12. The method of claim 10 further comprising delivering, with the AMR, the first donor tote to a storage area when there is a storage location for the first donor tote, and alternatively delivering, with the AMR, the first donor tote to the waiting area when there is not an available storage location in the storage area for the first donor tote.

13. The method of claim 12, wherein the AMR with the first donor tote, when in the storage area, remains at the storage area until either there is an available storage location in the storage area or the order is active at another picking station.

14. The method of claim 8, wherein each AMR of at least a subset of AMRs of said plurality of AMRs comprises an onboard computer programmed with computer code for performing order fulfillment operations.

15. A method of task allocation for a material handling system having a plurality of autonomous mobile robots (AMRs) for retrieving, transporting, and delivering items to and from locations within a material handling facility, said method comprising:
accessing, with an AMR, a list of available tasks, wherein the list of available tasks are accessed via a network;
selecting, with the AMR, a next task for the AMR from the list of available tasks;
wherein said selecting a next task comprises selecting a task with either the lowest travel time or results in maximized order fulfillment throughput; and
wherein said accessing a list of available tasks is performed while a current task is finishing within a threshold period of time.

16. The method of claim 15, wherein said selecting a new task comprises selecting a task based upon at least one of a pool of available tasks, an urgency of the task, an origin of the task, and/or destination locations of the available tasks, the AMR's current location, and any customer requirements or the material handling facility's requirements.

17. The method of claim 16, wherein said selecting a new task is also based upon the material handling capability of the AMR.

18. The method of claim 15 further comprising traveling, with the AMR, to the next task location, and while traveling, reviewing the list of available tasks to determine if there is an alternative task in the list of available tasks that is either a higher priority or requires less travel time than the next task.

19. The method of claim 17 further comprising switching to the alternative task when the alternative task has a higher priority or requires less travel time than the next task, and returning the next task to the list of available tasks.

20. The method of claim 15, wherein the AMR selecting the next task comprises an onboard computer with computer code for a workflow for selecting the next task from the list of available tasks.
